(19) United States
(12) Patent Application Publication
(10) Pub. No.: US 2007/0100558 A1
(43) Pub. Date: May 3, 2007

(54) Using biological models

(76) Inventors: Walter Fontana, Brighton, MA (US); L. Greg Meredith, Seattle, WA (US)

Correspondence Address: FISH & RICHARDSON PC, P.O. BOX 1022, MINNEAPOLIS, MN, 55440-1022, US

(21) Appl. No.: 11/430,314

(22) Filed: May 1, 2006

Related U.S. Application Data
(60) Provisional application No. 60/677,208, filed on May 2, 2005.
(60) Provisional application No. 60/677,160, filed on May 2, 2005.

(51) Int. Cl. G06F 19/00

(52) U.S. Cl. 702/19

(57) ABSTRACT

Among other things, using a computer to enable a user to express a behavioral motif with respect to at least one biological entity, and causing the expressed behavioral motif to be tested with respect to a model that represents at least part of the at least one biological entity and that has been expressed, at least in part, in a language that renders the model susceptible to testing for the expressed behavioral motif.

### CLAIM OF PRIORITY

This application claims priority under 35 USC §119(e) to U.S. patent application Ser. No. 60/677,208, and U.S. patent application Ser. No. 60/677,160, both filed on May 2, 2005, the entire contents of both of which are hereby incorporated by reference.

### BACKGROUND

Models of biological processes can be of different types and can be expressed in different ways depending on the skill, choice, or focus of the modeler or the goal of the model.

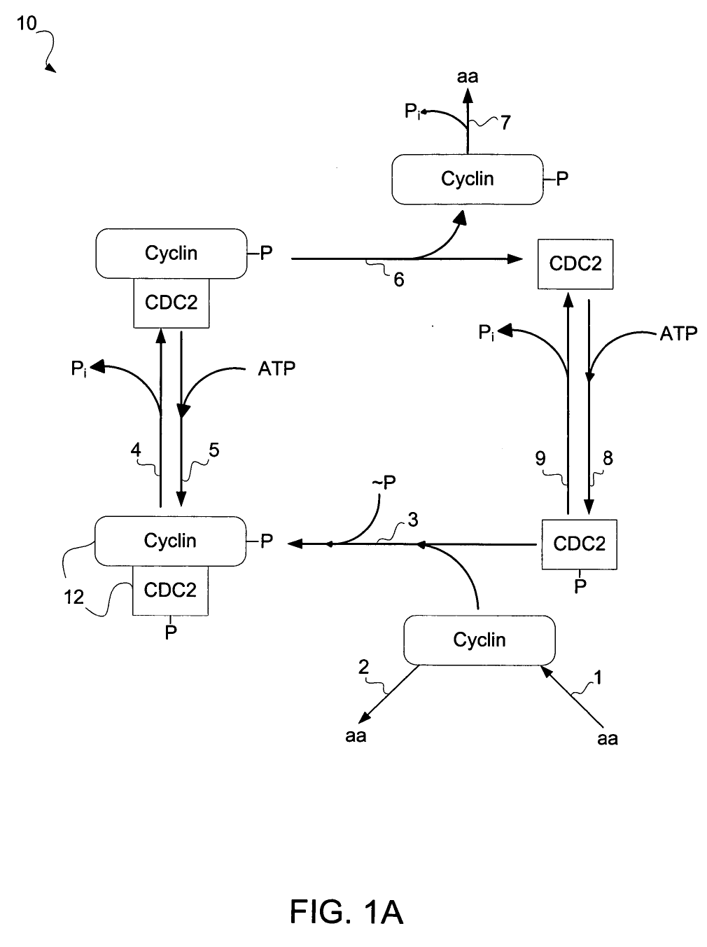

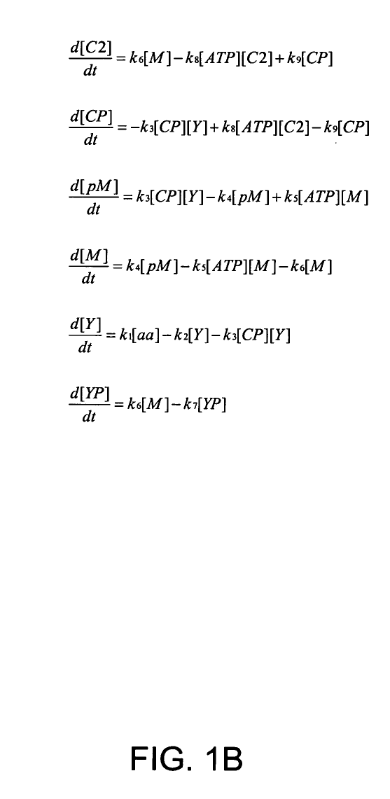

FIG. 1A is an example of one type of model 10 of a biological system, in this case an interaction of two proteins (cyclin and CDC2) during a process of cell division. Other reacting species include amino acids (“aa”) and adenosine triphosphate (“ATP”), and inorganic phosphates (“Pᵢ”). The labeled boxes 12 represent chemical structures (such as proteins) that interact with each other in a way postulated by the model. Each reaction has been labeled with a number 1-9 for ease of reference in what follows. Similar diagrams can be employed to model processes on other scales. For example, in similar diagrams, the labeled boxes may represent, for example, sites on a single protein, cell components, cells, or collections of cells.

FIG. 1B is another type of model that expresses the same interactions using differential equations. Here, [C2] denotes the concentration of CDC2; [CP] denotes the concentration of CDC2-P; [pM] denotes the concentration of P-cyclin-cdc2-P; [M] denotes the concentration of P-cyclin-cdc2; [Y] denotes the concentration of cyclin; [YP] denotes the concentration of cyclin-P; and t denotes time. The kᵢ terms are rate constants, and the [aa] and [ATP] terms are modeled as constants.

Some models are susceptible to automated model checking in which a specific query about a biological process can be tested against a model to produce a result (usually yes or no) that depends on whether the model is consistent or inconsistent with the posed query.

### SUMMARY

In general, in one aspect, enabling a user to express a behavioral motif with respect to at least one biological entity, and causing the expressed behavioral motif to be tested with respect to a model that represents at least part of the at least one biological entity and that has been expressed, at least in part, in a language that renders the model susceptible to testing for the expressed behavioral motif.

Implementations may include one or more of the following features. The behavioral motif includes an interaction of the biological entity with an environmental entity. The environmental entity is associated with a therapy. The therapy includes a chemical compound or biochemical material. Based on the outcome of the determination, selecting a chemical compound for further evaluation. Further evaluation is selected from a computer-based evaluation or an experimental evaluation. Further evaluation comprises contacting a selected chemical compound with a target molecule, cell-free system, cell-based system, or animal. The biological entity includes an animal. The biological entity includes an environmental entity. The behavioral motif encompasses different specific behaviors of the biological entity. The enabling of the user to express the behavioral motif includes providing a graphical user interface. The causing of the motif to be tested with respect to the model includes using the motif as a query in a model checker, applying the model checker to the model, and returning a result based on the applying. The result indicates consistency of the behavioral motif with a behavior of the biological entity. The language comprises an agent-based language. The agent-based language comprises π-calculus. Also causing the behavioral motif to be tested with respect to other models. The behavior motif is expressed in a scale-invariant way.

In general, in another aspect, expressing at least part of a system of reactions that represents at least part of a biological entity, in a language that renders the model susceptible to testing with respect to a behavioral motif.

Implementations may include one or more of the following features. The language comprises an agent-based language. The agent-based language comprises π-calculus.

In general, in another aspect, a user interface includes an element that receives from a user an expression of a behavioral motif with respect to at least one biological entity, and an element that enables a user to control at least one aspect of the use of the expressed behavioral motif with respect to a model that represents at least part of the biological entity.

Implementations may include one or more of the following features. The use of the expressed behavior motif includes using the expressed behavioral motif as a search query. The model includes a representation of a therapeutic agent in the presence of a pathological biological entity, and the use of the expressed behavioral motif also includes using the expressed behavioral motif to detect an effective treatment of the pathology by the therapeutic agent.

In general, in another aspect, using a user interface includes submitting an expression of a behavioral motif with respect to at least one biological entity, and receiving an indication of whether the expressed behavioral motif is present in a biological model that represents at least part of a biological entity in the presence of a therapeutic entity.

Implementations may include one or more of the following features. The received indication is affirmative, the method further comprising selecting the therapeutic entity for further evaluation. Further evaluation comprises computer-based or experimental testing. The received indication is negative, the method further comprising resubmitting the expression of the behavioral motif, and receiving an indication of whether the expressed behavioral motif is present in a different biological model that represents at least part of the biological entity in the presence of the therapeutic entity.

In general, in another aspect, enabling a user to use an automatic model checker to apply a query to two or more distinct models associated with a biological entity, and automatically returning to the user results of using the model checker to apply the query to the two or more distinct models.

Implementations may include one or more of the following features. The query represents a property that encompasses specific structural characteristics of the models. The query represents a behavioral motif that encompasses specific behaviors of the models. The models are accessed at different locations on a communication network. The results comprise logical indications of consistency of the query with behaviors of the models. At least parts of the models are expressed in a common language. The common language comprises an agent-based language. The agent-based language comprises π-calculus. The behavioral motif includes an interaction of the biological entity with an environmental entity. The environmental entity is associated with a therapy. The therapy includes a chemical or biochemical material. The biological entity includes an animal. The biological entity includes an environmental entity. The behavioral motif encompasses different specific behaviors of the biological entity.

In general, in another aspect, obtaining at least one base biological model; obtaining variation models; for each variation model, creating a test model by combining the variation model with the base model; determining which of the test models has a pre-determined property.

Implementations may include one or more of the following features. The determination is performed for at least 10, 100, 1,000, 10,000 or 100,000 variation models. Based the outcome of the determination, selecting a compound for further evaluation. Further evaluation is selected from a computer-based evaluation or an experimental evaluation. Experimental evaluation includes chemical-based evaluation. Further evaluation comprises contacting a selected compound with a target molecule, cell-free system, cell-based system, or animal. The variation models are each models of a chemical structure. The chemical structure corresponds to a candidate therapeutic agent. At least part of the biological and the variation models are expressed in a common language. The common language is an agent-based language. The agent-based language is π-calculus. Combining the variation model with the base model comprises representing the variation model and the base model as concurrent processes. The pre-determined property comprises a behavioral motif. The pre-determined property is indicative of a beneficial treatment of a pathology. Determining comprises employing a model checker to the test model. The variation model comprises a model of a chemical structure and the test model is determined to have the pre-determined property, also including identifying the chemical structure as a drug candidate.

In general, in another aspect, evaluating drug candidates includes receiving a drug candidate from a computational agent that identified the drug candidate according to a method described herein, and evaluating the drug candidate.

Implementations include one or more of the following features. Evaluating the drug candidate comprises experimental evaluation. Experimental evaluation includes chemical-based evaluation. Chemical-based evaluation includes contacting the drug candidate with a target molecule, cell-free system, cell-based system, or animal. Evaluating the drug candidate is performed 10, 100, 1,000, or 10,000 times.

Other aspects include other combinations of the features recited above and other features, expressed as methods, apparatus, systems, program products, and in other ways.

Any of the experimental methods described herein can be performed on compounds, systems or other entities that were selected by a method described herein. Thus the operator of the experimental method steps need not perform some or all the computer-based steps, but needs only to evaluate a compound selected by such a method.

Any of the methods described herein can include steps of creating databases or other records into which one or more of the results of a method described herein can be entered. Data described herein can be transmitted by fax, telephone, computer, or by communication over other electronic medium.

Other features and advantages will be apparent from the description and from the claims.

### DESCRIPTION

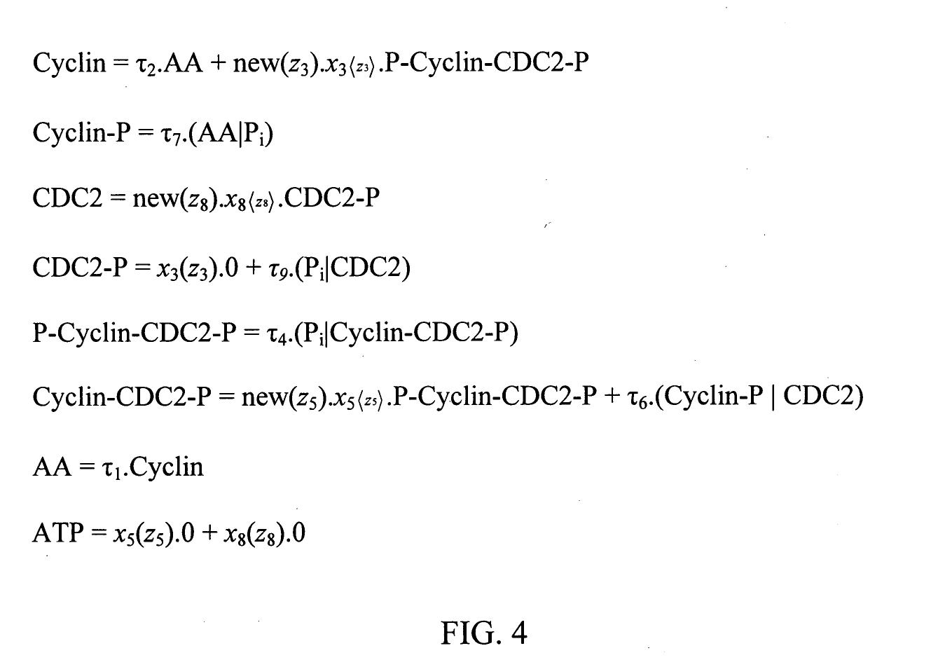

FIGS. 1A, 1B, and 4 are representations of biological models.

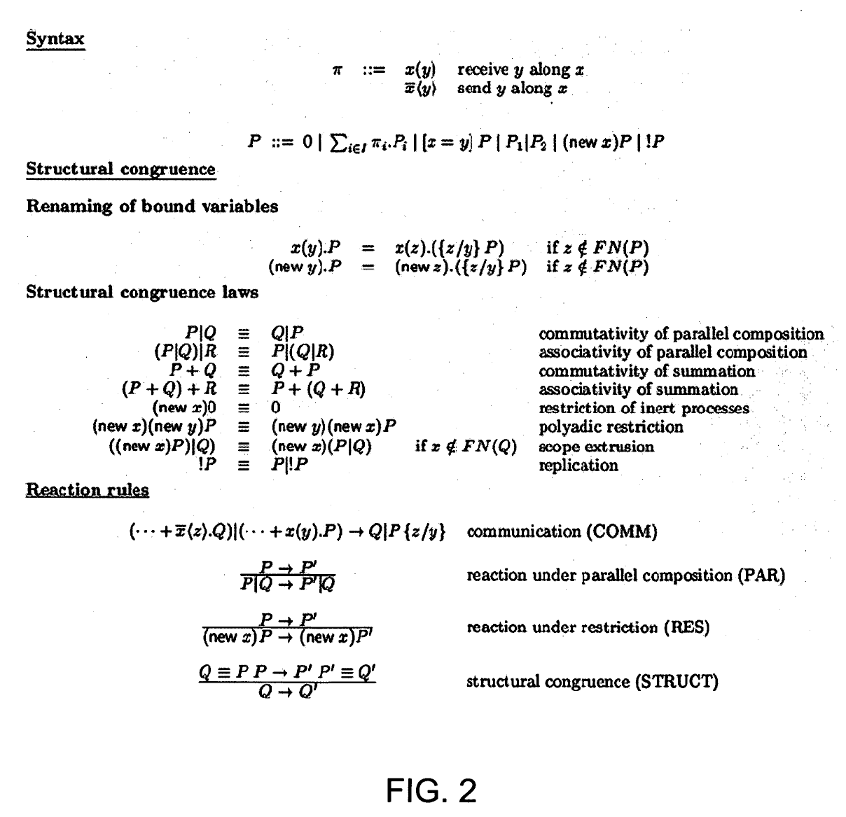

FIG. 2 is a chart of properties.

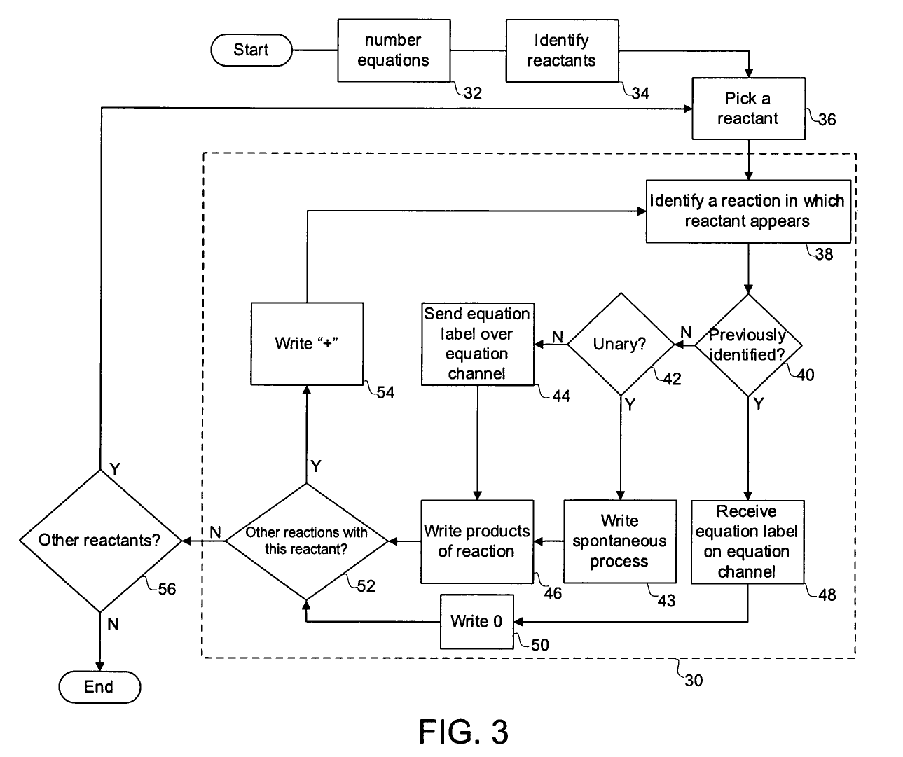

FIG. 3 is a flowchart.

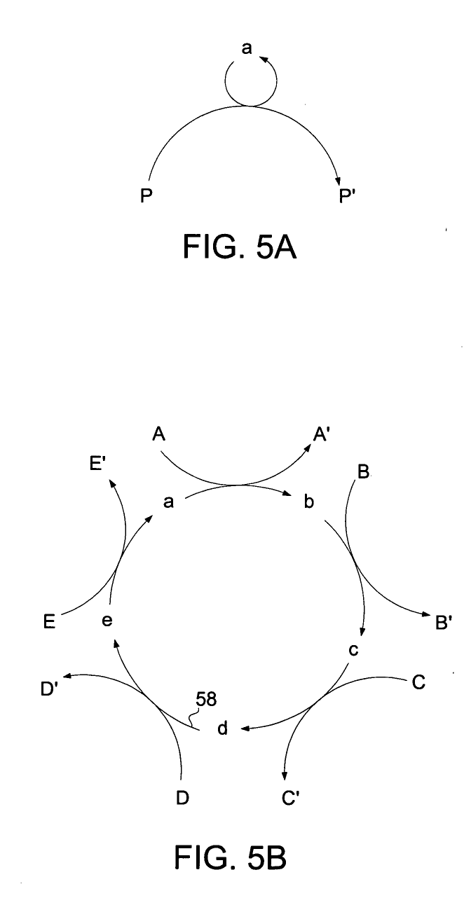

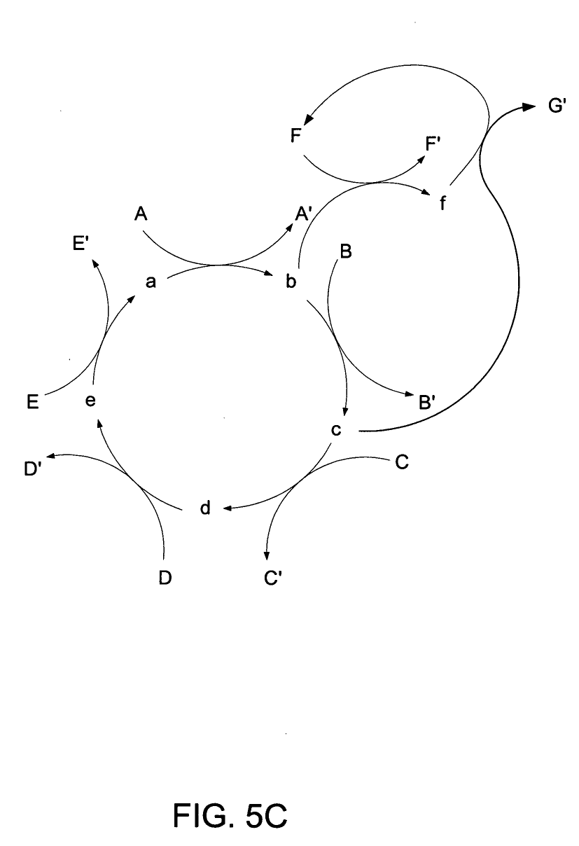

FIGS. 5A-C are representations of chemical reactions.

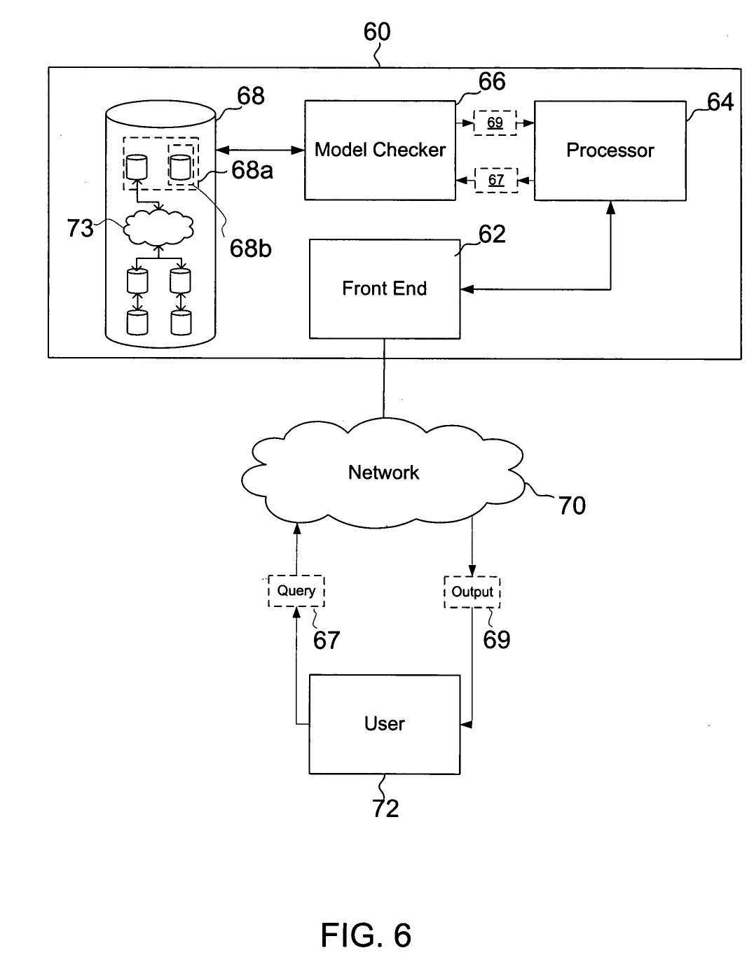

FIG. 6 is a schematic depiction of searching.

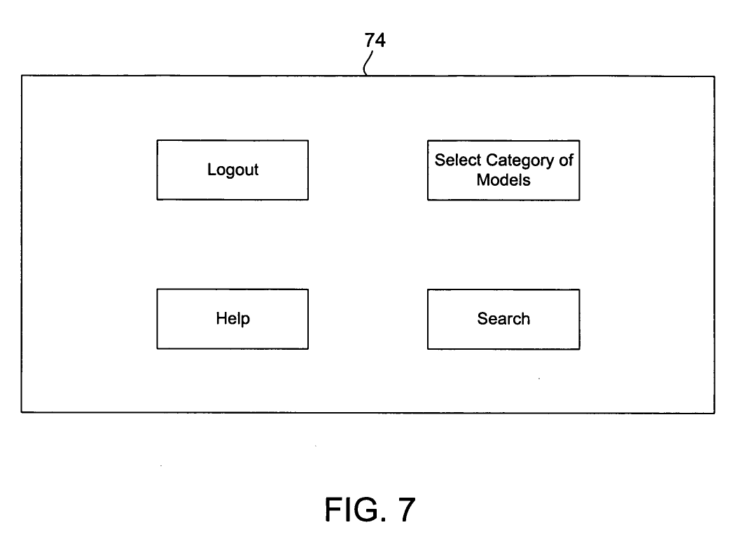

FIG. 7 is a schematic depiction of a user interface.

The models shown in FIGS. 1A and 1B are each useful in conveying certain aspects of a biological system, such as a system present in an animal. For example, it can be seen in FIG. 1A that reactions 1, 2, and 7 involve amino acids. By contrast, this cannot be seen as easily in FIG. 1B. As another example, determining the equilibrium concentration of CDC2 given certain initial conditions is relatively harder from FIG. 1A than from FIG. 1B.

Generally, FIG. 1A provides a relatively rich description of the biological process, but offers less information about the process's dynamics and is not amenable to immediate automated analysis. Conversely, FIG. 1B provides relatively detailed information on the process's dynamics and is amenable to automated analysis (e.g., using a differential equation solver), but is not very descriptive.

Another type of model of the same biological process that is descriptive and illustrative of the process's dynamics can be created using an agent-based language, such as π calculus. Generally, agent-based languages allow for defining agents and their potential interactions with other agents (conditioned on the participating agents' states) that result in redefining states and subsequent potential interactions for each agent. Agents are defined in terms of continuations subsequent to an interaction, so that their identity or lineage can be tracked (e.g., by a model checker) through the evolution of a system. Agent-based models of biological systems are therefore naturally testable with respect to queries pertaining to the identity or lineage of a biological entity. The π calculus is an agent-based formal language that was originally developed to provide mobility and concurrency in computer applications. The relevance of π calculus has since been recognized in the biological context as providing a language for modeling complex interactions. A summary of π calculus syntax is shown in FIG. 2.

Generally, π calculus is concerned with names and processes. Processes are agents. In this document, lowercase letters x, y, z . . . will denote names, and uppercase letters P, Q, R . . . will denote processes, unless otherwise specified. It is sometime useful (but not necessary) to regard a name as representing a communication channel. In this context, the symbol x(y) denotes receiving the name y on channel x, and the symbol x [symbol] y [symbol] denotes a process that sends the name y on channel x. Sometimes, sending a name is also denoted by including an overbar on the communication channel through which the name is sent, e.g., x̅ [symbol] y [symbol] .

Concurrent processes are separated by a “|” symbol; for example, P|Q denotes concurrent processes P and Q. Sequential processes are separated by a “.” symbol; for example, P.Q denotes sequential processes P and Q, with process P occurring before process Q. In this case, P is said to prefix Q, and Q is said to be in the continuation of P. Processes that occur with mutual exclusivity may be combined by a “+” symbol. For example, P+Q denotes a process in which either P or Q occurs, but not both. New names may be introduced using the “new” operator, sometimes denoted by the Greek letter nu (ν). For example, the process new(z).x [symbol] z [symbol] creates a new name, z, and sends the name over the channel x, and the process x(z).P receives the name z over the channel x, and then does process P.

For syntactic completeness, the process 0 denotes the “zero process,” which generally denotes the termination of other processes. For example, P.Q.R.0 denotes process P, followed by process Q, followed by process R, followed by termination. Furthermore, the “spontaneous process,” denoted τ, is a process that self-initiates.

A system of reactions can be translated into a π calculus model, for example, by the steps illustrated in FIG. 3. The system of reactions is assumed to be labeled in some way that uniquely identifies each reaction. For example, the reactions may be numbered (step 32), with the order of the numbering being immaterial. For reversible reactions, the forward reaction receives a separate label from the reverse reaction.

In what follows, the words “reactants” and “products” are used to describe the translation process. There is no requirement that the reactions of a model be limited to chemical reactions. For example, if large molecules take part in reactions in a model, then other reactions can model the internal behavior of each molecule itself by expressing the molecule as a series of interacting components, thereby creating a small portion of the model. Such models are amenable to translation despite the fact that there may be no “reactants” or “products” in the chemical sense. Similarly, one may specify reactions in which each “reactant” is modeled as constituting several mutually-interacting components, as in a cell or organelle thereby creating a larger portion of the model. Use of the words “reactants” and “products” below does not preclude these models' translatability.

First, the reacting species (both reactants and products) are identified (step 34). For example, in the reactions shown in FIG. 1A, the reacting species are: cyclin, P-cyclin, CDC2, CDC2-P, P-cyclin-CDC2-P, P-cyclin-CDC2, aa, Pᵢ, and ATP. Each of the reacting species corresponds to a distinct process in the π calculus model. Once the reacting species have been identified, the translator picks a reactant (step 36). To define the process corresponding to the selected reactant, the translator cycles through the loop 30 for each reaction in which the given reactant appears.

In the loop 30, the translator first identifies a reaction in which the reactant appears (step 38) and determines whether the reaction has previously been identified in a previous iteration of the loop 30 in connection with a different reactant (step 40).

If the reaction has not previously been identified, the translator determines whether the reaction is a unary reaction (step 42), that is, a reaction having only one reactant. If the reaction is unary, the translator writes a “spontaneous process” symbol (step 43) optionally indexed by the reaction number. Otherwise, the translator creates a new name and a new channel, each corresponding to the reaction, and writes an expression for sending the new name over the new channel (step 44). In some cases, step 44 may be omitted. However, step 44 is helpful to provide opportunities to synchronize internal interactions of a reactant in further refinements of the model. The process creating the name and sending it over the new channel is prefixed to the products of the given reaction under consideration (step 46), where the products are written as concurrent processes.

On the other hand, if the translator determines that the reaction has previously been identified in step 42, then the translator writes an expression for receiving the reaction name over the reaction channel (step 50). (The reaction and channel names already exist, because step 46 was carried out the first time the reaction was identified.) This receiving process is prefixed to the zero process.

Optionally, fewer than all the products of the reaction may be listed in step 46, and the omitted products may be listed in future iterations of the loop 30 in place of writing the 0 process in step 50. Doing so has no computational impact on the π calculus model but can make it more readable. For example, consider the reaction:
A+B→A′+B′

Suppose, for example, that A and B are large proteins, and a phosphate group is passed from A to B. The notation in which this reaction is expressed suggests that A′ is related to A, and B′ is related to B. However, nothing in loop 30 allows the translator to appreciate this notational feature. Iterating the loop 30 described above for the reactants A and B produces the π calculus statements:
A=new(z).xz.(A′|B′)
B=x(z).0
However, the following statements:
A=new(z).xz.A′
B=x(z).B′
encode essentially the same dynamics and contain the same information as the previous set and also illustrate more closely the relationship between A, A′, B, and B′. The translator may opt to translate some or all of the reactions employing this technique. Generally, any product omitted from the expression in step 46 is listed in step 50 instead of “0” during later iterations of loop 30.

Steps 46 and 50 employs the characteristics of agent-based languages to track reactants as they change through the reactions of the model. A model-checker (described below) can therefore identify behaviors of the reactants (or of the modeled system) that may not be apparent simply from the state of the modeled system at any given time. In the example reaction A+B →A′+B′, for instance, the π calculus statement not only encodes the reaction, but also specifies that A becomes A′.

After either step 46 or step 50, the reaction under consideration has been accounted for in the π calculus model. The translator looks for other reactions involving this reactant (step 52). If there are other reactions, the translator writes “+” (step 54), moves to the next reaction, and performs the above steps for the next reaction. Once the reactions involving this reactant have been accounted for, the translator looks for other reactants that have yet to be expressed in the π calculus model (step 56). The translator performs the above loop 30 for each of these reactants. If there are no more reactants, the translation has been completed.

The translator may be hardware, software, a human, or any combination of these. Hardware implementations of the translator may include a processor configured to carry out the steps above, for example, by executing instructions for carrying out the steps stored on a data storage medium in data communication with the processor.

Different modelers using this translation process will produce compatible models. This “schematization” of modeling can increase the productivity of modelers and the quality of models in a variety of ways. For example, modelers independently studying complementary aspects of a single biological entity can readily combine their models by specifying reactions between a subset of agents in the models.

FIG. 4 is a list of π calculus statements obtained by applying the translation technique described above to the equations shown in FIG. 1A, where the reactants were ordered as follows: cyclin, P-cyclin, CDC2, CDC2-P, P-cyclin-CDC2-P, P-cyclin-CDC2, aa, Pi, and ATP. The resultant string of π calculus sentences contains the same information as the reactions displayed in FIG. 1A. For example, one can tell which reactions involve which reactants by examining FIG. 4. Furthermore, a collection of π calculus statements can be readily analyzed by a number of computer-based tools.

One of these tools is a model checker. Generally, model checking refers to determining automatically whether a given model satisfies a user-expressed query, for example, whether the model contains a state in which a particular protein is suppressed. One way of performing model checking using computational tree logic (“CTL”) in this context is described in Appendix A and incorporated here by reference: Chabrier-Rivier et al., “Modeling and Querying Biological Networks,” 25 Theoretical Computer Science 325 (September, 2004). There are a variety of query languages with which a user can express a query to be used by the model checker.

The result returned by the model checker is typically either yes or no, indicating that query either is satisfied or is not satisfied by the model. Optionally, a model checker may inform the user whether it is possible to test the model against the query. Testing a query may be precluded when, for example, the query is: syntactically inconsistent; expressed in a way unrecognizable to the model checker; or expressed in a way that is incompatible with the model.

An agent-based query language can be used with CTL-based or other model checking techniques to search for behavioral motifs. A behavioral motif generally refers to a qualitative or functional description of how a part of a modeled system operates. The word motif connotes a pattern that is either recurrent with greater than expected frequency in biological entities, or is a pattern that is otherwise of interest to a researcher, regardless of the frequency with which it occurs in biological entities. The word behavioral connotes that an observable function or known purpose is associated with the motif. For example, in systems biology, common behavioral motifs include signal amplification, signal filtering, delaying signal relays, or generalized enzymes.

Behavioral motifs reveal how a system or parts of a system function or interact with environmental entities external to the motif, rather than merely describe the structural or mechanical details of the system, such as whether a given state can be reached, whether there is a path connecting one state to another, whether the system is stable, or how long it takes to attain a particular state. In general, there can be several structural configurations that correspond to a single behavioral motif. By way of analogy only, a particular reaction in a biological model is akin to a transistor or other simple component in a complicated piece of electronics, and a behavioral motif is akin to an integrated circuit for performing a particular function built from transistors. Just as transistors and other simple components can be assembled (in a variety of ways) to assemble a clock circuit, reactions can be specified in a variety of ways to correspond to a single behavioral motif.

For example, suppose the models shown in FIG. 5A and FIG. 5B are tested using a query that asks the model checker whether there is an “X that reacts and becomes X.” Single molecules satisfying this query are called catalysts or, in the biological context, enzymes. FIG. 5A shows a model containing only one reaction: P+a→P′+a. This is an archetypical reaction involving the catalyst “a,” and the model checker will identify the agent “a” satisfying the query.

In FIG. 5B, the model contains five reactions:
A+a→A′+b
B+b→B′+c
C+c→C′+d
D+d→D′+e
E+e→E′+a
None of the individual reactions involves or exhibits a property of a catalyst per se. However, the structure of the model is such that the “circuit” 58 formed from the species a, b, c, d, e remains throughout the operation of the model. If the query is interpreted by the model checker as “identify every agent X that reacts and becomes X,” the model checker identifies the circuit 58 as satisfying the query. This is because in agent-based languages, agents are identified independently of their internal structure. Such a model checker identifies the individual agents a, b, c, d, e (none of which satisfy the query), as well as the agent X={a, b, c, d, e} (which satisfies the above query) Indeed, in FIG. 5B, the “self-maintaining system” or “generalized enzyme” agent X={a, b, c, d, e} can be identified as satisfying the query even if each of {a, b, c, d, e} were specified in the model as having a relatively complicated internal structure.

In this sense, a behavioral motif (and a query describing the motif) is scale invariant. Searching in a scale invariant way is desirable, because the searcher need not know a priori the level of detail with which a particular model is expressed. For example, scale invariant searching is useful in a search of a large database of models including models not created by and unknown to the searcher.

Behavioral motifs are not merely structural patterns. Although a behavioral pattern may ultimately be linked to a particular structure (FIGS. 5A and 5B), such a structure or behavioral pattern need not be initially present in the model. The modeled system may evolve to exhibit a behavioral motif that is not extant in its initial state.

For example, the system of FIG. 5B, here regarded as a “base” model, can be perturbed by specifying a variation, as in FIG. 5C. In FIG. 5C, a new agent F is added to the model. If the base model includes information for how the old agents react with F (or agents making up an internal structure of F), the combined system generates new agents as shown in FIG. 5C. Eventually, the string of reactions regenerates the new agent F. From this point on, the external addition of F is no longer needed, as F is effectively produced endogenously. The original self-maintaining system {a, b, c, d, e} has thus been extended to {a, b, c, d, e, F, f}, and would also be detected by the above query.

By further illustration, another behavioral motif is illustrated in the above example. The system of FIG. 5C would also satisfy the query “identify a self-maintaining system Y [FIG. 5C] containing a self-maintaining system X [FIG. 5B] and F such that Y results from the addition of F to X.” Such a query may be employed in the context in which the system X represents a pathological metabolic pathway in a patient, F represents a therapeutic agent, and Y represents a nominal or improved metabolic pathway. Alternatively, the same behavioral motifs shown in FIGS. 5B and 5C may describe a gene regulatory sequence. For example, the lower-case letters in FIGS. 5B and 5C may represent genes, and the upper case letters may represent transcription factors that activate the genes with which they interact (with A′=A, B′=B, . . . E′=E, F′=F). FIG. 5B, in this context, describes a circuit 58 of mutually-activating genes. If this circuit 58 is pathological, then one may be searching for a drug F which alters the circuit 58 to conform to what is shown in FIG. 5C.

Expressing a model using an agent-based language such as π calculus as described above allows the construction of a search system shown in FIG. 6. The search system 60 includes a front end module 62 in data communication with a processor 64. The processor 64 is in data communication with a model checker 66, which itself is in data communication with a database 68 of models.

The model checker 66 is hardware or software, or a combination of hardware and software, that can determine whether a model satisfies a user-specified query 67, and provides an output 69 indicative of whether the model satisfies the query. The model checker 66 can be a program running or residing on, e.g., a personal computer, a server, or a parallel computing network. The model checker 66 can determine whether a model satisfies a particular query as described in Chabrier-Rivier et al above, or in another standard way.

The processor 64 is hardware, software, or a combination of hardware and software that receives queries 67 from the front end module 62 and invokes the model checker 66. The processor collects the outputs 69 of the model checker 66 as it cycles through the database 68, and passes the outputs to the front end module 62, where they are displayed to the user 72 in the form of search results. The processor 64 may be a program running or residing on, e.g., a personal computer, a server, or a parallel computing network.

The database 68 of models includes a storage medium such as a magnetic or optical disk, or a collection of such media, that houses data representations of the models in the database 68. The database 68 can be distributed over several different locations, not all of which need be in data communication with each other. For example, each of several universities or laboratories can house storage media that are parts of the database 68, where only some of the universities or laboratories are connected to a particular communication network 73. The database 68 can have any logical structure, including no structure, and in that sense we use the term database in a non-technical sense of a set of data. The models may not be consistently expressed, for example, may not be available at a single time or place or under a common set of conditions. For example, the models in the database may be organized in groups 68a or subgroups 68b, according to subject matter or according to a characteristic of a user 72 required to access the model (e.g., whether the user is a “basic” or “premium” subscriber to the search system 60). The database 68 is in data communication with the model checker 66 in a standard way, for example over a local area network, wide area network, or by direct connection.

A user 72 searches the database 68 through the front end module 62. The front end module 62 is hardware or software that passes user-supplied queries to the processor 64 and displays the results of the user's query to the user. The front end module 62 may be software, hardware, or a combination of software and hardware.

Referring to FIG. 7, for example, the front end module may include a web server with instructions for providing a graphical user interface 74 to the user 72. The graphical user interface 74 presents facets of the search system 60 to the user 72, such as allowing the user 72 to log out of the system, to specify search queries, to limit the scope of the user's search to particular groups of models, to obtain help on an aspect of the search system 60, etc.

Referring back to FIG. 6, the user 72 may connect to the front end module 62 across a local- or wide-area network 70, or by other type data communication. Before passing a user's query to the processor 64, the front end module 64 can optionally verify the syntactic consistency of the query.

The search system 60 has applications to drug discovery. In this context, consider a drug developer that is in the early stages of developing a drug or a therapeutic agent to treat a certain condition. Suppose, for example, the drug developer is searching for a drug that would stimulate production of a particular protein in an animal during bone marrow production. Suppose that the drug developer has a long list of drug candidates, each of which may stimulate the production of the protein in bone marrow production when ingested by the animal.

To help shorten the list of drug candidates, the drug developer creates a new database 68 of models based on one or more existing models of bone marrow production. Each model in the new database is based on an existing model of bone marrow production that may also model the presence of a candidate drug. A new model is created in this way for some or all of the available models of bone marrow production and some or all of the candidate drugs. The drug developer then queries the new database 68 with a query expressing that the protein is stimulated in bone marrow production. If any models in the new database 68 do not possess this property, then the drug developer may conclude that the drug candidate that gave rise to the model is less likely to produce the desired results. Insofar as querying a database of models is less expensive or faster than laboratory testing of drug candidates, employing the search system 60 in this manner may be advantageous for a drug developer who is on a development schedule or who is without infinite financial resources.

Once a list of drug candidates has been identified in this manner, further testing of the drug candidates may be initiated. Such further testing can include other computer-based testing, or can include experimental testing in a laboratory or clinical setting. For example, the experimental testing can include chemical-based testing, such as contacting a target molecule, cell-based or cell-free system, or animal to the drug candidate and observing the effect of the drug candidate on the target molecule, cell-based or cell-free system, or animal. Such experimental testing can be repeated any number of times to establish results within desired statistical parameters.

Other embodiments are within the scope of the following claims.

What is claimed is:

1. A computer-based method comprising
enabling a user to express a behavioral motif with respect to at least one biological entity, and
causing the expressed behavioral motif to be tested with respect to a model that represents at least part of the at least one biological entity and that has been expressed, at least in part, in a language that renders the model susceptible to testing for the expressed behavioral motif.

2. The method of claim 1 in which the behavioral motif includes an interaction of the biological entity with an environmental entity.

3. The method of claim 2 in which the environmental entity is associated with a therapy.

4. The method of claim 3 in which the therapy includes a chemical compound or biochemical material.

5. The method of claim 4, further comprising, based the outcome of the determination, selecting a chemical compound for further evaluation.

6. The method of claim 5, wherein further evaluation is selected from a computer-based evaluation or an experimental evaluation.

7. The method of claim 6, wherein said further evaluation comprises contacting a selected chemical compound with a target molecule, cell-free system, cell-based system, or animal.

8. The method of claim 1 in which the biological entity includes an animal.

9. The method of claim 1 in which the biological entity includes an environmental entity.

10. The method of claim 1 in which the behavioral motif encompasses different specific behaviors of the biological entity.

11. The method of claim 1 in which the enabling of the user to express the behavioral motif includes providing a graphical user interface.

12. The method of claim 1 in which the causing of the motif to be tested with respect to the model includes using the motif as a query in a model checker; applying the model checker to the model, and returning a result based on the applying.

13. The method of claim 12 in which the result indicates consistency of the behavioral motif with a behavior of the biological entity.

14. The method of claim 1 in which the language comprises an agent-based language.

15. The method of claim 14 in which the agent-based language comprises π-calculus.

16. The method of claim 1 also including causing the behavioral motif to be tested with respect to other models.

17. The method of claim 1 in which the behavior motif is expressed in a scale-invariant way.

18. A computer-based method comprising
expressing at least part of a system of reactions that represents at least part of a biological entity, in a language that renders the model susceptible to testing with respect to a behavioral motif.

19. The method of claim 18 in which the language comprises an agent-based language.

20. The method of claim 19 in which the agent-based language comprises π-calculus.

21. A computer-based user interface comprising
an element that receives from a user an expression of a behavioral motif with respect to at least one biological entity, and
an element that enables a user to control at least one aspect of the use of the expressed behavioral motif with respect to a model that represents at least part of the biological entity.

22. The user interface of claim 21, in which the use of the expressed behavior motif includes using the expressed behavioral motif as a search query.

23. The user interface of claim 22, in which the model includes a representation of a therapeutic agent in the presence of a pathological biological entity, and the use of the expressed behavioral motif also includes using the expressed behavioral motif to detect an effective treatment of the pathology by the therapeutic agent.

24. A method of using a computer-based user interface comprising
submitting an expression of a behavioral motif with respect to at least one biological entity,
receiving an indication of whether the expressed behavioral motif is present in a biological model that represents at least part of a biological entity in the presence of a therapeutic entity

25. The method of claim 24 in which the received indication is affirmative, the method further comprising selecting the therapeutic entity for further evaluation.

26. The method of claim 25 in which further evaluation comprises computer-based or experimental testing.

27. The method of claim 24 in which the received indication is negative, the method further comprising resubmitting the expression of the behavioral motif, and receiving an indication of whether the expressed behavioral motif is present in a different biological model that represents at least part of the biological entity in the presence of the therapeutic entity.

28. A computer-based method comprising
enabling a user to use an automatic model checker to apply a query to two or more distinct models associated with a biological entity, and
automatically returning to the user results of using the model checker to apply the query to the two or more distinct models.

29. The method of claim 28 in which the query represents a property that encompasses specific structural characteristics of the models.

30. The method of claim 28 in which the query represents a behavioral motif that encompasses specific behaviors of the models.

31. The method of claim 28 in which the models are accessed at different locations on a communication network.

32. The method of claim 28 in which the results comprise logical indications of consistency of the query with behaviors of the models.

33. The method of claim 28 in which at least parts of the models are expressed in a common language.

34. The method of claim 33 in which the common language comprises an agent-based language.

35. The method of claim 34 in which the agent-based language comprises π-calculus.

36. The method of claim 30 in which the behavioral proposition includes an interaction of the biological entity with an environmental entity.

37. The method of claim 36 in which the environmental entity is associated with a therapy.

38. The method of claim 37 in which the therapy includes a chemical or biochemical material.

39. The method of claim 28 in which the biological entity includes an animal.

40. The method of claim 28 in which the biological entity includes an environmental entity.

41. The method of claim 30 in which the behavioral motif encompasses different specific behaviors of the biological entity.

42. A computer-based method comprising:
obtaining at least one base biological model;
obtaining variation models;
for each variation model, creating a test model by combining the variation model with the base model;
determining which of the test models has a pre-determined property.

43. The method of claim 42, wherein said determination is performed for at least 10, 100, 1,000, 10,000 or 100,000 variation models.

44. The method of claim 43, further comprising, based the outcome of the determination, selecting a compound for further evaluation.

45. The method of claim 44, wherein said further evaluation is selected from a computer-based evaluation or an experimental evaluation.

46. The method of claim 45 in which experimental evaluation includes chemical-based evaluation.

47. The method of claim 45, wherein said further evaluation comprises contacting a selected compound with a target molecule, cell-free system, cell-based system, or animal.

48. The method of claim 42 in which the variation models are each models of a chemical structure.

49. The method of claim 42 in which the chemical structure corresponds to a candidate therapeutic agent.

50. The method of claim 42 in which at least part of the biological and the variation models are expressed in a common language.

51. The method of claim 50 in which the common language is an agent-based language.

52. The method of claim 51 in which the agent-based language is π-calculus.

53. The method of claim 52 in which combining the variation model with the base model comprises representing the variation model and the base model as concurrent processes.

54. The method of claim 42 in which the pre-determined property comprises a behavioral motif.

55. The method of claim 42 in which the pre-determined property is indicative of a beneficial treatment of a pathology.

56. The method of claim 42 in which determining comprises employing a model checker to the test model.

57. The method of claim 55 in which the variation model comprises a model of a chemical structure and the test model is determined to have the pre-determined property, also including identifying the chemical structure as a drug candidate.

58. A method of evaluating drug candidates comprising:
receiving a drug candidate from a computational agent that identified the drug candidate according to the method of claim 42, and
evaluating the drug candidate

59. The method of claim 58 in which evaluating the drug candidate comprises experimental evaluation.

60. The method of claim 59 in which experimental evaluation includes chemical-based evaluation.

61. The method of claim 60 in which chemical-based evaluation includes contacting the drug candidate with a target molecule, cell-free system, cell-based system, or animal.

62. The method of claim 58 further comprising evaluating the drug candidate is performed 10, 100, 1,000, or 10,000 times.

63. A medium bearing instructions to cause an apparatus to
enable a user to express a behavioral motif with respect to at least one biological entity, and
cause the expressed behavioral motif to be tested with respect to a model that represents at least part of the at least one biological entity and that has been expressed, at least in part, in a language that renders the model susceptible to testing for the expressed behavioral motif.

64. A medium bearing instructions to cause an apparatus to
express at least part of a system of reactions that represents at least part of a biological entity, in a language that renders the model susceptible to testing with respect to a behavioral motif.

65. A medium bearing instructions to cause an apparatus to
enable a user to use an automatic model checker to apply a query to two or more distinct models associated with a biological entity, and
automatically return to the user results of using the model checker to apply the query to the two or more distinct models.

66. A medium bearing instructions to cause an apparatus to obtain at least one base biological model;
obtain variation models;
for each variation model, create a test model by combining the variation model with the base model;
determine which of the test models has a pre-determined property.
